(19) United States
(12) Patent Application Publication
(10) Pub. No.: US 2006/0231577 A1
(43) Pub. Date: Oct. 19, 2006

(54) Viscous liquid dispensing pump

(76) Inventors: David James Sealy Powling, West Sussex (GB); Jesus-Maria Zubillaga, Durana (ES)

Correspondence Address: DORITY & MANNING, P.A., POST OFFICE BOX 1449, GREENVILLE, SC, 29602-1449, US

(21) Appl. No.: 10/533,205

(22) PCT Filed: Oct. 31, 2003
(86) PCT No.: PCT/GB03/04700

§ 371 Date: Mar. 20, 2006

(30) Foreign Application Priority Data
Nov. 4, 2002 (GB) 0225641.0

(51) Int. Cl. G01F 11/00

(52) U.S. Cl. 222/321.9

(57) ABSTRACT

A dispensing pump (12) for a viscous liquid comprises a cylinder (16), a piston (24) mounted for reciprocation within said cylinder (16), an inlet (50) for admitting liquid to be dispensed into said cylinder (16) and a ball check valve (52) arranged selectively to open and close said inlet opening. The ball valve (52) is retained in position by a spring (58) having a variable diameter. The piston (24) has a dispensing passage (40) in fluid communication with said cylinder (16) and with a self sealing dispensing valve (38). The pump (12) further comprises a sliding cut-off valve (70) arranged selectively to open and close fluid communication between the piston dispensing passage (40) and the cylinder (16) as the piston (24) reciprocates within the cylinder (16).

### FIELD OF THE INVENTION

The present invention relates to pumps for dispensing viscous liquids such as soap, shampoo, lotion and food products.

### BACKGROUND OF THE INVENTION

Various viscous liquid dispensers are known. The dispenser typically comprises a reservoir for containing the product to be dispensed and a dispensing pump for dispensing the product from the reservoir.

Such dispensers are commonly used in public rest rooms, where they are typically wall mounted. In such dispensers the dispensing pump is usually provided at the lower part of the dispenser, below the reservoir. The reservoir may itself be attached to a fixed surface or be housed in a housing which is so mounted. A pump actuator may be provided on the dispenser housing to actuate the dispensing pump. The liquid reservoir may be vented or unvented. Examples of such dispensers are disclosed in U.S. Pat. No. 5,556,005 and International Patent Application WO02/49490.

In other dispensers, more typically used for domestic purposes, the dispensing pump may be mounted in the to of a free-standing container such a glass or bottle containing the liquid to be dispensed and the product dispensed by a user pressing down on the pump to dispense the liquid through a spout. Such dispensers are widely available on the market, for example as soap dispensers.

WO02/49490 discloses a dispensing pump having a pump chamber having an inlet at one end for receiving liquid to be dispensed and a dispensing piston moveable within that chamber to dispense the liquid. The inlet opening of the chamber is selectively opened and closed by a check valve. The dispensing piston is provided with a dispensing passage which communicates with a self-sealing valve member arranged in an outlet. As the piston is pressed into the chamber by a suitable actuator, the check valve closes the inlet opening such that liquid within the dispensing chamber passes along the dispensing passage and out through the self-sealing dispensing valve. When the piston is released it returns under the force of the spring. As it is released, the piston generates a partial vacuum within the dispensing chamber which causes the self-sealing valve to close and then open the check valve to allow a further charge of liquid to be admitted into the dispensing chamber. This process may be repeated as many times as desired.

In the arrangement shown in WO02/49490, liquid is admitted to the dispensing pump from a vented container. This means that the liquid within the liquid reservoir is at atmospheric pressure throughout the process. A problem may arise, however, if the dispensing pump disclosed in WO02/49490 is used to receive liquid from an unvented reservoir. In such circumstances, the reservoir would normally comprise a bag which collapses as liquid is dispensed therefrom. This prevents air entering the reservoir and coming into contact with its contents. Such contact is undesirable as it may lead to contamination by airborne contaminants. However, the pressure of the liquid within the reservoir falls below atmospheric pressure as liquid is dispensed therefrom. This means that when the pressure in the reservoir falls sufficiently low, air will vent back through the self-sealing valve which, as explained above, is undesirable.

The present invention seeks to overcome or at least alleviate the above problems and from a first aspect provides a dispensing pump for a viscous liquid comprising:

a cylinder;

a piston mounted for reciprocation within said cylinder;

an inlet for admitting liquid to be dispensed into said cylinder;

a check valve arranged selectively to open and close said inlet opening;

said piston having a dispensing passage in fluid communication with said cylinder and with a dispensing valve;

wherein said pump further comprises a cut-off valve arranged selectively to open and close fluid communication between the piston dispensing passage and the cylinder as the piston reciprocates within the cylinder.

Thus in accordance with the invention a cut-off valve is arranged between the dispensing piston and the dispensing cylinder so as to control the communication therebetween. In the dispensing stroke the valve opens to allow liquid to pass from the dispensing cylinder into the piston dispensing passage, but in the return stroke, the valve closes the inlet so as to isolate the piston dispenser passage from the cylinder. In the event, therefore, of the pressure within the liquid reservoir becoming very low, this pressure is isolated from the dispensing piston passage thereby preventing air being sucked back through the dispensing valve, preventing contamination of the contents of the reservoir.

The cut-off valve may comprise a sliding valve member which is arranged to reciprocate within the dispensing cylinder so as selectively to open and close one or more openings in the dispensing piston. The openings in the piston may be formed in a side wall of the piston, and the valve member slidably engages an outer surface of the dispensing piston.

The piston may be provided with a pair of axially spaced shoulders so as to limit the axial movement of the valve member therealong.

The cut-off valve member may comprise a radially outer wall for engaging the inner surface of the cylinder and a radially inner wall for engaging the piston. These walls may be connected by a radially extending web. This arrangement allows for a certain misalignment between the axes of the piston and cylinder.

The check valve may be of any suitable construction, for example one such as shown in WO02/49490. In certain embodiments, however, it comprises a ball which is received in a valve seat in the inlet opening. The ball may be retained by a spring. That spring may also act as a return spring for the dispensing piston, and it may spring locate over the end of the dispensing piston.

The spring may be formed with a variable diameter so as to retain the ball adjacent the opening. The spring means may be configured and arranged such that during the return stroke of the dispensing piston the ball is maintained in the inlet opening until the cut-off valve closes, whereupon it opens to admit more liquid into the dispensing cylinder.

The dispensing valve is, in certain embodiments, a self-sealing valve, such as an elastomeric valve. Such valves are widely used in dispensing and examples are shown in, inter alia U.S. Pat. Nos. 5,213,216, 5,339,995, 5,337,877, 5,409,144, 5,439,143, 5,839,614, 5,927,566, 5,944,234, 5,971,232, 6,112,951, 6,112,952 and 6,112,806. The content of these specifications is incorporated herein by reference.

As can be seen from these specifications, these valve typically comprise a flexible membrane formed with a plurality of slits which define a number of flaps in the membrane. The flaps open outwardly under application of pressure to allow liquid to be dispensed and resile back to close and seal the membrane after removal of the pressure.

The advantage of using such a valve is that it prevents or reduces the likelihood of liquid in the dispensing channels hardening in or becoming contaminated by the ambient air.

The axis of the self sealing valve may be formed at an obtuse angle to the axis of the piston.

It will be appreciated that the present invention also extends to a liquid dispenser comprising a liquid receiving reservoir and a dispensing pump in accordance with the invention arranged to dispense liquid therefrom.

In certain embodiments, the dispensing pump may be mounted to a lower part of the reservoir, for example, by a screw thread or other fitting. The reservoir itself may be housed in a suitable housing which may be attached to a supporting surface such as a wall.

In certain embodiments of the invention, the reservoir may be unvented. This is where the present invention is particularly useful for the reasons mentioned above. In other embodiments, however, the reservoir may be vented. Accordingly, a dispensing pump in accordance with the invention could be used in conjunction with a vented reservoir such as that shown in WO02/49490.

The invention may also be used with free-standing liquid dispensers. In such arrangements, the pump would typically be supported in the neck of a liquid receiving reservoir such as a plastics or glass bottle and the pump piston depressed to dispense the product. Such dispensers are vented since the liquid receiving reservoir is not collapsible. In such embodiments, therefore, the pump may be provided with an air vent which allows air to enter the receptacle around the pump piston.

The pump cylinder may be provided with a vent opening which is in fluid communication with a space formed between the cylinder and the dispensing piston so that air can pass between the cylinder and the piston, thereby by-passing the dispensing valve.

### BRIEF DESCRIPTION OF THE DRAWINGS

Some preferred embodiments of the invention will now be described by way of example only, with reference to the accompanying drawings, in which:

FIG. 1 shows a first dispenser incorporating a pump in accordance with the invention;

FIG. 2 shows the pump of FIG. 1 in greater detail;

FIG. 3 shows a second dispenser incorporating pump in accordance with the invention; and

FIG. 4 shows the dispensing pump of FIG. 3 in greater detail.

### DESCRIPTION OF PREFERRED EMBODIMENTS OF THE INVENTION

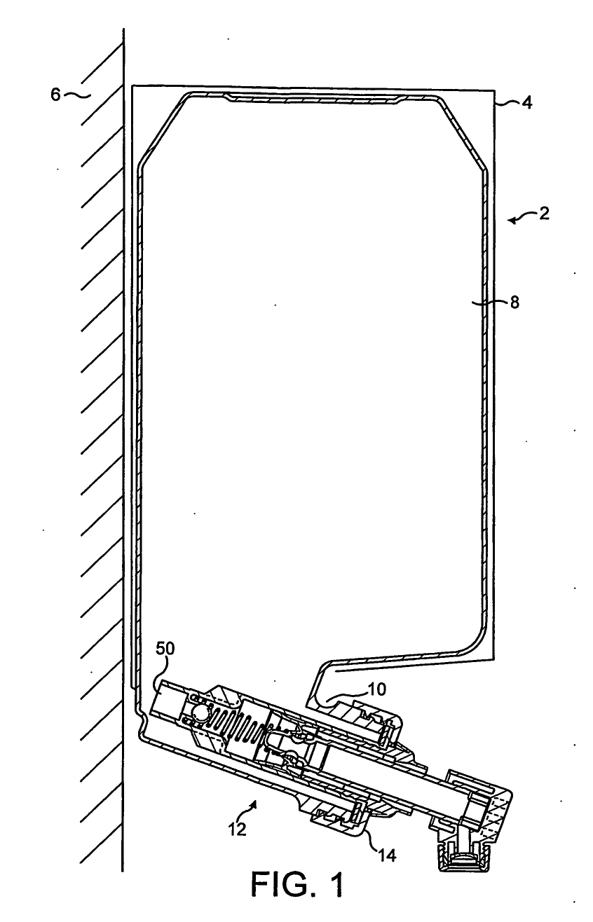

With reference to FIG. 1, a dispenser 2 for dispensing viscous liquid such as soap, shampoo or lotion comprises a housing 4 mounted to a support structure such as a wall 6.

The housing 4 houses a collapsible plastic reservoir 8 containing the liquid to be dispensed. The reservoir 8 is formed with an integral outlet 10 in which a dispensing pump 12 in accordance with the invention is mounted through a screw cap 14.

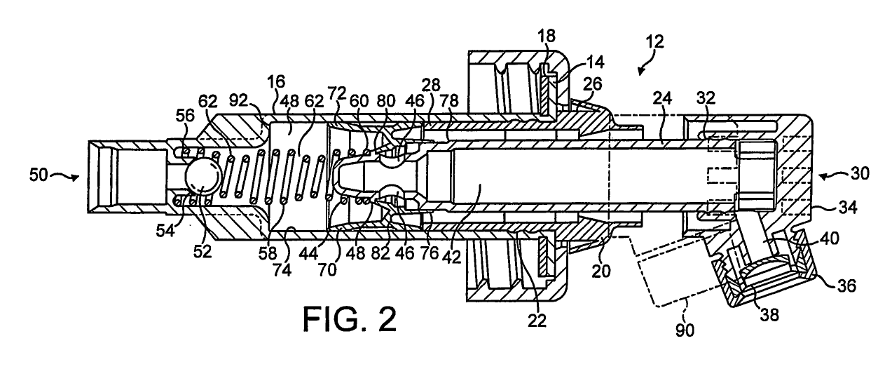

The pump 12 will be described in greater detail with reference to FIG. 2.

The dispensing pump 12 comprises a moulded plastics cylinder 16 which is provided with a retaining flange 18 at one end, for engagement with the mounting cap 14 a plastics collar 20 snap fits into grooves 22 provided adjacent the flange 18 on the cylinder 16.

The collar 20 slidably receives a reciprocating dispensing piston 24. The dispensing piston 24 is formed with ribs 26 which engage the inner wall 28 of the collar 20.

A self-sealing valve unit 30 is mounted on one end 32 of the dispensing piston 24.

The self-sealing valve unit 30 comprises a moulding 34 which fits onto the end 32 of the dispensing piston 24 and a cap 36 which retains an elastomeric self-sealing valve element 38. This type of valve element 38 is well known in the art, as exemplified in the various US patent specifications referred to above. The particular valve element 38 shown in this embodiment is an RV21 valve produced by Liquid Molding Systems Inc. of Midland; Mich., USA, although an E11-145 valve produced by the same company may also be used advantageously.

The valve element 38 is positioned at the end of a dispensing passage 40 within the moulding 34 which is in fluid communication with a dispensing passage 42 formed within the dispensing piston 24. The axis of the valve element 38 and dispensing passage 40 is formed at an obtuse angle to the axis of the piston 24.

The left-hand end 44 of the dispensing piston 24 is closed but two opposed, equi-spaced, openings 46 are provided through the wall 48 of the dispensing piston 42 adjacent the end 44. This provides fluid communication between the dispensing passage 42 of the dispensing piston 24 and a dispensing chamber 48 formed between the pump cylinder 16 and the dispensing piston 24.

A liquid inlet 50 is provided in the left-hand end of the cylinder 16. This inlet is selectively opened and closed by a ball valve 52 received on a conical seat 54 formed in the cylinder moulding. An annular groove 56 is provided around the valve seat 54 to receive one end of a coil spring 58 whose other end locates over the end 44 of the piston 24 to abut a shoulder 60 provided on the piston 24. The spring 58 thus acts as a return spring for the dispensing piston 24.

The spring 58 is provided with reduced diameter sections 62 for engaging the ball 52 for purposes which will be described below. The spring 58 is symmetrical so that it can be inserted in either direction during assembly.

A plastics cut-off valve 70 is also mounted within the cylinder 16. The valve 70 comprises a first annular wall 72 which slides in a sealing manner along the inner surface 74 of the cylinder 16. A second annular wall 76 is received slidably on the outer wall 48 of the dispensing piston 24 between shoulders 78 and 80. The walls 72,76 are joined by a web 82. As will be described further below, the wall 76 selectively opens and closes the openings 46 in the wall 48 of the dispensing piston 24.

Operation of the dispensing pump will now be described.

When it is desired to dispense liquid from the receptacle 8, a user pushes the right-hand end of the dispensing piston 24 inwardly towards the position 90 shown in dotted lines in FIG. 2. As the piston 24 moves to the left, liquid within the dispensing chamber 48 becomes pressurised causing the ball valve 52 to seal against its seat 50 preventing liquid escaping through the inlet 50 back into the reservoir 8.

This elevated pressure also maintains the slide valve 70 in the position shown in FIG. 2 during the initial movement of the piston 24. This exposes the openings 46 in the piston 24, placing the dispensing chamber 48 in fluid communication with the dispensing passage 42 in the piston 42. As soon as fluid communication is established, liquid in the chamber 48 can enter the discharge passages 40,42 (which will already contain liquid from earlier dispensing operations) and be discharged through the outlet valve 38.

After this initial movement of the piston 24 the slide valve wall 76 abuts the shoulder 78 provided on the piston 24, whereafter the slide valve 70 and piston 24 move together, continuing dispensing of the liquid during the dispensing stroke. The stroke ends when the moulding 34 abuts the collar 20.

At the end of the dispensing stroke of the piston 24, the ball valve 52 is closed and the openings 46 in the piston are open.

When the piston 24 is released, it moves to the right under the action of the return spring 58. As the piston 24 begins to move to the right, the spring 58 maintains the ball valve 52 against its seat 54 to prevent a new charge of liquid entering the dispensing chamber 48. During the initial movement of the piston 24, the slide valve 70 also remains in its left-most position so that the piston 24 moves to the right with respect to the slide valve 70, closing the openings 46. The openings 46 are fully closed when the inner wall 76 of the slide valve 70 abuts the shoulder 80 provided on the piston 24. The piston 24 and slide valve 70 then move back together.

By maintaining the ball valve 52 closed during the initial movement, a partial pressure is generated within the chamber causing the self sealing valve 38 to close off cleanly.

Once the slide valve 70 closes the openings 46 in the piston wall 48 the discharge chamber 48 becomes isolated from the discharge passages 40,42. Further movement of the piston 24 to the right back to the position shown in FIG. 2 then creates a partial vacuum in the discharge chamber 48 thereby opening the ball valve 52 allowing a new charge of liquid to enter the dispensing chamber 48 ready for dispensing by the next pump stroke.

The advantage of using the slide valve 70 is that as the liquid reservoir 8 collapses a partial vacuum will be developed in the reservoir 8. Without the cut-off valve 70 arranged between the dispensing chamber 48 and the discharge valve 38, air could be sucked in through the valve 38 back into the reservoir 8 leading to possible contamination of the reservoir contents.

As stated in the introduction above, the dispensing pump of the present invention is not limited in application to non-vented containers. It could, therefore, be used in a dispenser such as shown in WO02/49490 in which the liquid reservoir is vented.

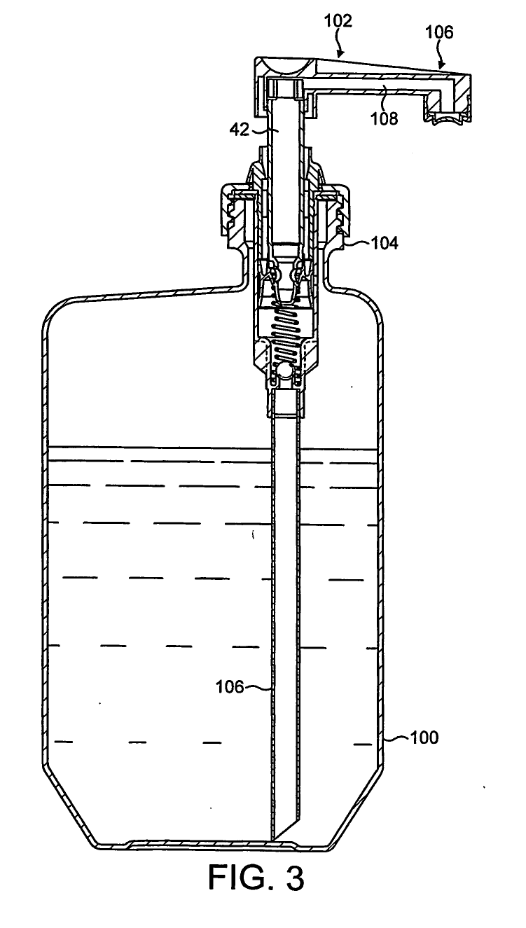

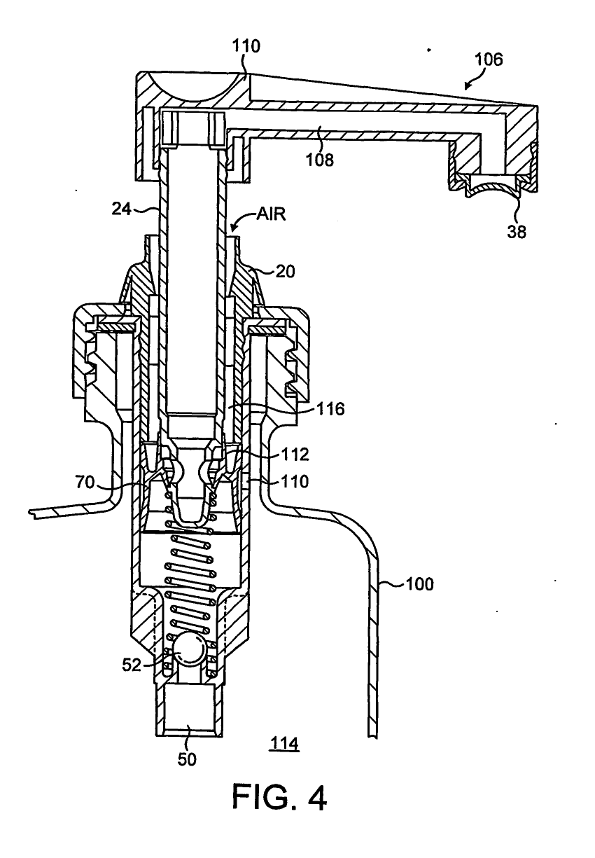

The dispensing pump of the present invention may also be used in free standing liquid dispensers such as shown in FIGS. 3 and 4.

In this embodiment, a bottle 100 has a dispensing pump 102 mounted in its neck 104. A dip tube 106 extends down into the bottle 100. The pump 102 of this embodiment is substantially the same as that shown in FIGS. 1 and 2, but there are a number of modifications as will be described in further detail below. Features which are common with the first embodiment will be referred to by the same reference numerals as in the first embodiment.

In this embodiment, the self-cleaning valve unit 106 is modified to permit the liquid to be dispensed downwardly. To this end, the unit 106 is provided with a elongated discharge passage 108 in a moulding 110 which leads from the dispensing passage 42 of the piston 24. The valve member 38 is an E11-145 valve as described with reference to the earlier embodiment.

The other significant difference over the pump shown in FIGS. 1 and 2 is that an air vent 110 is provided through the outer wall 112 of the pump body 16. The air vent 110 is covered by the slide valve member 70 when the piston is in its uppermost position as shown in FIG. 4 but is uncovered as the piston 24 and valve 70 move downwardly during the dispensing stroke. Once uncovered, it vents the interior space 114 of the bottle 100 to atmosphere via the annular space 116 between the piston 24 and collar 20.

The operation of the pump in the embodiment of FIGS. 3 and 4 is the same as in that of the earlier embodiment. As the piston 24 is depressed by a user, ball valve 52 closes the liquid inlet 50 and slide valve 70 exposes the openings 46 in the piston to allow liquid within the dispensing chamber 48 to enter to the discharge passage 42 of the piston and displace liquid already in the discharge passages 42, 108 through the valve 38.

When the piston 24 is released, it returns upwardly under the force of return spring 58. The ball valve 52 is maintained closed momentarily while the slide valve 70 closes the openings 46 to produce a partial vacuum in the dispensing channels 40,108 causing the valve 38 to seal cleanly. Thereafter the ball valve 52 opens to admit a new charge of liquid into the dispensing chamber 48.

The interior space 114 of the bottle 100 will remain vented to atmosphere during most of the dispensing operation but will be sealed off at the end of the return piston stroke.

It will be appreciated that the above embodiments are exemplary only and that variations may be made to these embodiments without departing from the scope of the invention. For example, while the invention has been described with reference to dispensing soap and the like, it can also be used in other fields. Other fields of interest include, but are not limited to, food service (dispensing liquids such as mustard, ketchup, sauces, and so on), industrial (dispensing liquids such as hard surface cleaners, general purpose cleaners, degreasers, and so on), and medical (dispensing liquids such as disinfectants, sterilants, bacteristats, virustats, and so on).

1. A dispensing pump for a viscous liquid comprising:
a cylinder;
a piston mounted for reciprocation within said cylinder;
an inlet for admitting liquid to be dispensed into said cylinder;
a check valve arranged selectively to open and close said inlet opening;
said piston having a dispensing passage in fluid communication with said cylinder and with a dispensing valve;
wherein said pump further comprises a cut-off valve arranged selectively to open and close fluid communication between the piston dispensing passage and the cylinder as the piston reciprocates within the cylinder.

2. A pump as claimed in claim 1 wherein the cut-off valve comprises a sliding valve member which is arranged to reciprocate within the dispensing cylinder so as selectively to open and close one or more openings in the dispensing piston.

3. A pump as claimed in claim 2 wherein the openings in the piston are formed in a side wall of the piston, and the valve member slidably engages an outer surface of the piston.

4. A pump as claimed in claim 2 or 3 wherein the piston is provided with a pair of axially spaced shoulders so as to limit the axial movement of the valve member thereon.

5. A pump as claimed in any of claims 2 to 5 wherein the cut-off valve member comprises a radially outer wall for engaging the inner surface of the cylinder and a radially inner wall for engaging the piston.

6. A pump as claimed in claim 5 wherein the inner and outer walls are connected by a radially extending web.

7. A pump as claimed in any preceding claim wherein the check valve comprises a ball valve comprising a ball received upon a valve seat.

8. A pump as claimed in claim 7 wherein the ball is retained by a spring.

9. A pump as claimed in claim 8 wherein the ball is retained by a return spring for the dispensing piston.

10. A pump as claimed in claim 9 wherein the spring locates over the end of the dispensing piston.

11. A pump as claimed in claim 8, 9 or 10 wherein the spring is formed with a variable diameter so as to retain the ball adjacent the opening.

12. A pump as claimed in claim 8, 9, 10 or 11 wherein the spring is configured and arranged such that during the return stroke of the dispensing piston the ball is maintained in the inlet opening until the cut-off valve closes.

13. A pump as claimed in any preceding claim wherein the dispensing valve is a self-sealing valve.

14. A pump as claimed in claim 13 wherein the valve is an elastomeric valve.

15. A pump as claimed in any preceding claim comprising an air vent which allows air to enter a reservoir receiving the pump around the pump piston.

16. A dispenser for viscous liquids comprising a reservoir for the liquid to be dispensed and a dispensing pump as claimed in any preceding claim arranged to dispense liquid from the reservoir.

17. A dispenser as claimed in claim 16 wherein the dispensing pump is mounted to an outlet of the reservoir.

18. A dispenser as claimed in claim 16 or 17 wherein the reservoir is housed in a housing for attachment to a supporting surface.

19. A dispenser as claimed in claim 16 or 17 wherein the reservoir is free standing.

20. A dispenser as claimed in any of claims 16 to 19 wherein the reservoir is unvented.

21. A dispenser as claimed in any of claims 16 to 19 wherein the reservoir is vented.
